(19) United States
(12) Patent Application Publication
(10) Pub. No.: US 2026/0060876 A1
(43) Pub. Date: Mar. 5, 2026

(54) Medical Chair Walker

(71) Applicant: Reginald K Sapp, Clinton, MD (US)

(72) Inventor: Reginald K Sapp, Clinton, MD (US)

(21) Appl. No.: 19/380,724

(22) Filed: Nov. 5, 2025

(51) Int. Cl. A61H 3/04

(52) U.S. Cl. CPC A61H 3/04; A61H 2003/046; A61H 2201/1633

(57) ABSTRACT

The Medical chair Walker is an invention with handbrakes FIG. 1A. The chair has a seat FIG. 1C for resting and wheels FIG. 1B for easy traveling. Its height will adjust up or down FIG. 1F for each customer. There are guides on each side FIG. 1D.

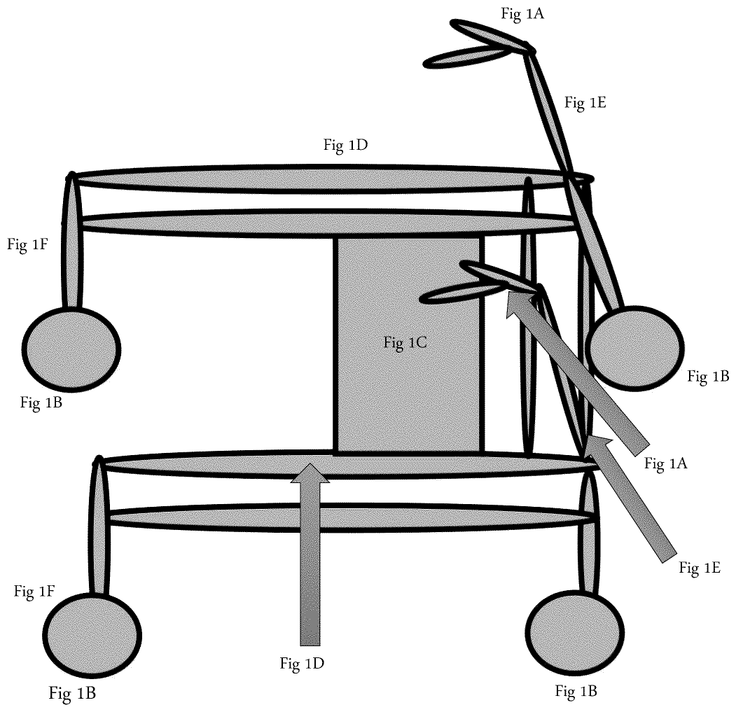

The handbrakes FIG. 1A were configured from a 10-speed bicycle.

A traveling Medical Chair Walker for anyone who needs support to walk, finger exercise and rest while traveling by foot.

The medical walker chair has the compacity to move 5 lb to 2000 lbs+ with the use of wheel FIG. 1B on the bottom and handbrake FIG. 1A to stop. The chair is stopped by hand brakes FIG. 1A and if need to rest, the seat FIG. 1C is there to sit and rest.

The device allows the owner to walk with support using guides FIG. 1D to exercise or just walking using their legs.

The handbrakes FIG. 1A will help disable and Arthritis patients. The device has four legs with wheels FIG. 1B on all four legs. The guide FIG. 1F which Telegraphs up and down for height.

The handbrakes FIG. 1A and the hand brake guide FIG. 1E are used to support the walking to a point and from a point. They can stop and rest with on the seat FIG. 1C that is built into the walker.

1. We founded in nursing home that the elderly patients were using walkers that they had to pick up and put down to walk with.
The research in airplane wheels and landing results in building a model and putting wheels on them FIG. 1B. Also, in nursing home it was understood that elderly patient need to sit to bath. A seat was incorporated to the walker FIG. 1C.
It was incorporated in the invention of the Medical Chair Walker with Wheels FIG. 1B and Handbrake FIG. 1A.
This research also allowed me to test a hand brakes from a bicycle (10 speed).
